(19) United States
(12) Patent Application Publication
(10) Pub. No.: US 2008/0068158 A1
(43) Pub. Date: Mar. 20, 2008

(54) DANGER SENSING INFORMATION DEVICE

(76) Inventors: Takashi SUMIYOSHI, Kokubunji (JP); Akio Amano, Tokyo (JP); Masahito Togami, Higashiyamato (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/765,225

(22) Filed: Jun. 19, 2007

(30) Foreign Application Priority Data
Sep. 15, 2006 (JP) 2006-250239

(51) Int. Cl. G08B 21/00

(52) U.S. Cl. 340/540; 340/573.1

(57) ABSTRACT

In a device for sensing and informing danger which is held by a person to be protected without requiring any active actions from the person to be protected, the number of false reports and miss-detections is reduced. A function of comparing the audio signals acquired from the microphone with the audio signal model of the person to be protected that has been stored inside, and a function of calculating the degree of danger from the speech intervals from the person to be protected and the speech intervals from the person not to be protected are provided in the device.

### CLAIM OF PRIORITY

The present application claims priority from Japanese application JP 2006-250239 filed on Sep. 15, 2006, the content of which is hereby incorporated by reference into this application.

### FIELD OF THE INVENTION

The present invention relates to a portable device that senses danger to the owner from the sound received and informs it.

### BACKGROUND OF THE INVENTION

A device preventing crimes against the weak including school children and infants (hereinafter referred to as those to be protected) is socially in demand and a burglar alarm (included one of the functions of a cellular phone) has been used commonly as a typical example. However, since an active action is required by those to be protected, such as pressing a switch to operate the device, such a device does not function under the situation wherein those to be protected are restrained or frightened. If there is a mechanism for sensing and informing danger using a variety of sensors without requiring any active actions from those to be protected, a device coping with a variety of situations can be implemented.

As the conventional invention having such mechanism, a device disclosed in JP-T No. 2004-531800 is known. In this device, the information from a variety of sensors for audio, images and temperature is determined in order to detect abnormalities in infants or to detect invaders.

### SUMMARY OF THE INVENTION

When implementing a device that is owned by those to be protected for sensing and informing danger without requiring any active actions from those to be protected, if the art mentioned in the aforementioned JP-T No. 2004-531800 is applied, false reports and/or miss-detections may be easily occurred since no mechanism is available for a variety of variance factors in the activities of those to be protected.

In order to solve the problems, a danger sensing information device according to an embodiment of the present invention is provided with a function for comparing the audio signals acquired from a microphone with the audio signal model of those to be protected and a function for calculating a degree of danger from the speech intervals of those to be protected and the speech intervals of those who are not protected. This is a necessary information for determining the case that is considered to be dangerous in the activities of those to be protected, and by integrating such information, a danger sensing information device with limited false reports and miss-detections can be implemented.

According to an embodiment of the present invention, the crime prevention effect is superior to that of the prior art due to limited false reports and miss-detections.

### BRIEF DESCRIPTION OF THE DRAWINGS

FIG. 1 is a configuration diagram of a danger sensing information device according to an embodiment of the present invention;

FIG. 2 is a configuration diagram of a danger audio detection unit of a danger sensing information device according to an embodiment of the present invention;

FIG. 3 is a configuration diagram of a child audio detection unit of a danger sensing information device according to an embodiment of the present invention;

FIG. 4 is a configuration diagram of a noise volume measurement unit of a danger sensing information device according to an embodiment of the present invention;

FIG. 5 is a graph showing the function of the degree of noise danger; and

FIG. 6 is a flowchart of a danger decision unit of a danger sensing information device according to an embodiment of the present invention.

### DETAILED DESCRIPTION OF THE PREFERRED EMBODIMENTS

A danger sensing information device according to an embodiment of the present invention is explained below with reference to the drawings.

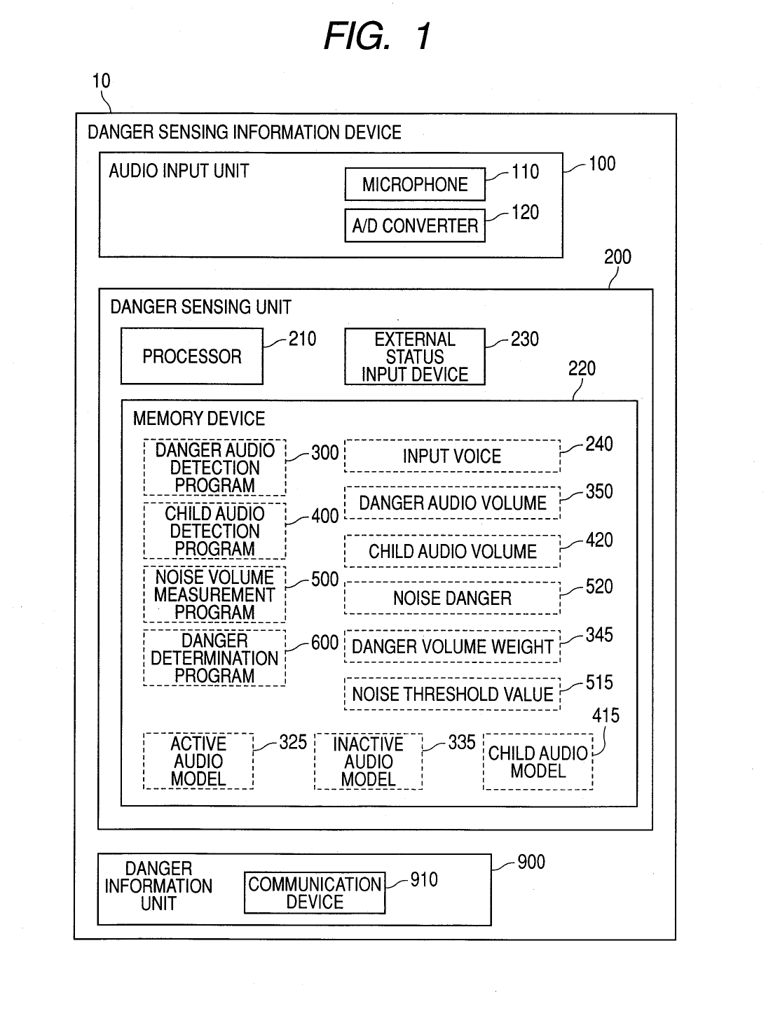

FIG. 1 shows a structure of a danger sensing information device 10 according to an embodiment of the present invention.

The danger sensing information device 10 is composed of an audio input unit 100, a danger sensing unit 200, and a danger information unit 900. The audio input unit 100 is provided with a microphone 110 and an A/D converter 120 wherein air vibrations due to the sound of a voice are captured and then converted to digital signals which are stored as input voice 240 in the memory device as will be explained later. The danger sensing unit 200 is composed of a processor 210, a memory device 220, and an external status input device 230. The memory device 220 contains each of programs such as a danger audio detection program 300, a child audio detection program 400, a noise volume measurement program 500, a danger determination program 600, an input voice 240, a danger audio volume 350, a child audio volume 420, a noise danger 520, danger audio weight 345, a noise threshold value 515, an active audio model 325, an inactive audio model 335, and a child audio model 415. The processor 210 performs a processing of input voice 240 using each program and transfers the results to the danger information unit 900. The details of the operation of each program will be explained later. The danger information unit 900 is provided with a communication device 910 which transmits the results of the danger sensing unit 200 to the outside.

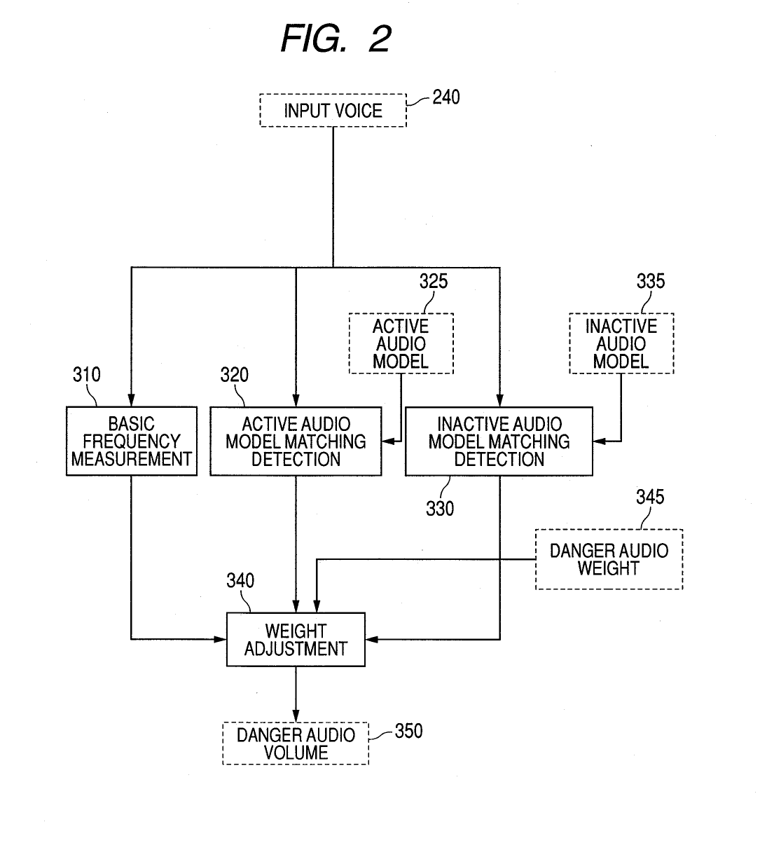

FIG. 2 shows processing that is performed by the danger audio detection program 300. The danger audio detection unit 300 is composed of a basic frequency measurement processing 310, an active audio model matching detection processing 320, an inactive audio model matching detection processing 330, and a weight adjustment processing 340.

In the basic frequency measurement processing 310, a basic frequency of the input voice 240 is calculated by an arbitrary method.

The active audio model matching detection processing 320 and the inactive audio model matching detection processing 330 calculate a degree of matching of the active audio model Ma and a degree of matching of the inactive audio model Mb, respectively, which indicate the degree of matching of input voice 240 with active audio model 325 and the inactive audio model 335, respectively.

For example, the degree of matching of the active audio model Ma is calculated using the following equation:

Ma=max Dai (i=1: Number of active audio models)

Dai=∥Finput−Fai∥

where Dai indicates a distance between the input voice and the active audio model i, Finput is a characteristic vector of the input voice, Fai is a characteristic vector of the active audio model i. For characteristic vectors, for example, MFCC (Mel Frequency Cepstrum Coefficients), LPC (Linear Prediction Coefficients), and auto relevant functions. As a result, a difference is calculated between the input voice and the active audio model having the closest acoustic characteristic to the input voice.

Mb is also calculated using the same equation as in the case of Ma.

Mb=max Dbi (i=1: Number of inactive audio models)

Dbi=∥Finput−Fbi∥

In the weight adjustment processing 340, the basic frequency f as the results of basic frequency measurement processing, the degree of matching Ma as the results of active audio model matching detection processing 320, and the degree of matching Mb as the results of inactive audio model matching detection processing 330 are weighted with a danger audio weight 345 and then added to calculate a danger audio volume 350 Cd. The danger audio volume Cd is calculated by the following equation wherein a basic frequency danger function is given by ff, danger audio weights are given by Wf, Wa and Wb:

Cd=Wf·ff(f)+Wa·Ma+Wb·Mb

where the basic frequency danger function ff is a function having a peak near the mean basic frequency fm of the speech of an adult male. For example, the following value is used:

ff(f)=|f−fm| if f>90 and f<130

0 otherwise

### The aforementioned fm, Wf, Wa, Wb are parameters that can be adjusted according to the user situation.

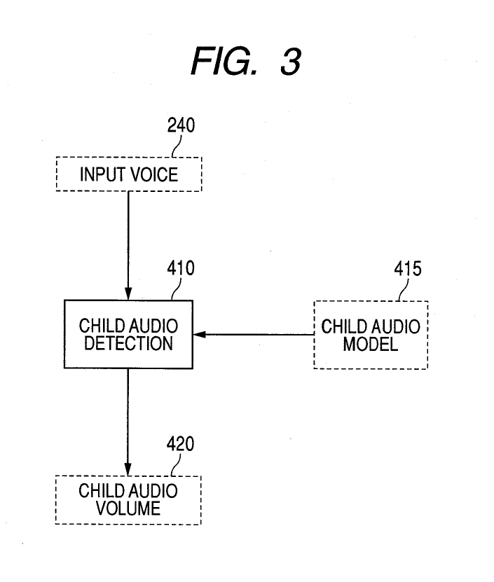

FIG. 3 shows a processing performed by the child audio detection program. The child audio detection processing 410 determines the degree of similarity between the input voice 240 and the child audio model 415 and outputs it as a child audio volume 420.

The child audio volume Cc is calculated by the following equation as in the cases of Ma and Mb.

Cc=max Dci (i=1: Number of child audio models)

Dci=∥Finput−Fci∥

FIG. 4 shows a processing performed by the noise volume measurement program 500. The noise volume measurement processing 510 calculates a noise volume of the input voice 240 (decibels, etc.) and compares it with the noise threshold value 515 to the calculated noise danger 520 to be output.

The noise danger Cs is calculated using the following equation:

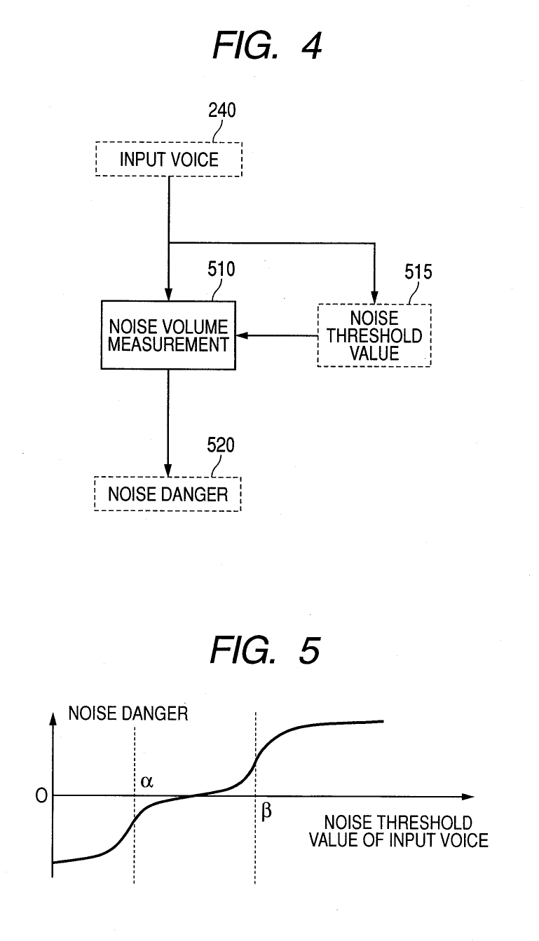

Cs=fs(N)

where N indicates a noise value of the input voice, fs is a function shown in FIG. 5. α and β in FIG. 5 are defined by the noise threshold value 515. Here, if the degree of noise danger is positive, noise is high and if it is negative, noise is low. The absolute value of the degree of noise danger expresses the respective degree of danger.

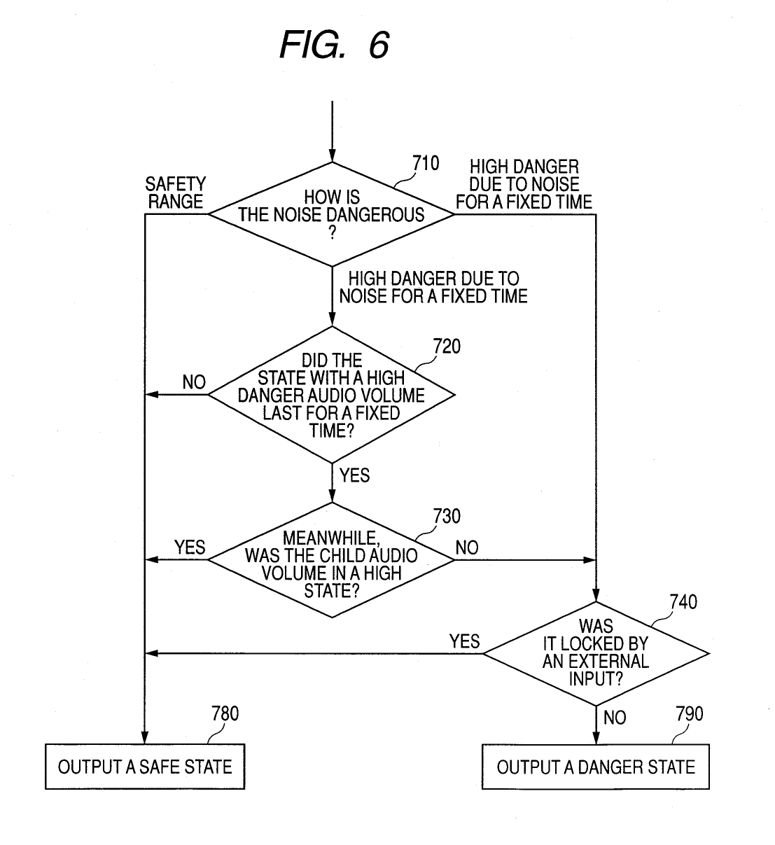

FIG. 6 shows a flowchart of the processing performed by the danger determination program 700.

Initially, the degree of noise danger 510 is analyzed in the determination 710. The distinction analysis is carried out as follows using the threshold values θa and θb.

### S1 if (θa<Cs and Cs<θb)

### S2 if (θb≦Cs)

### S3 if (Cs≦θa)

If the degree of noise danger is determined to be within the safe range (S1), a safe state is output (780). If the degree of danger is determined to be high due to the fact that the state with high noise continued for a fixed time (S2), the control shifts to the decision 740. If the degree of danger is determined to be low due to the fact that the state with low noise continued for a fixed time (S3), the control shifts to the decision 720. This processing is based on the hypotheses that in a place with abnormally high noise, dangers such as accidents or natural disasters are approaching the child or there is a high possibility of these, or that in a place with less noise, the number of passersby is less so that there is a higher possibility of running into an event of kidnapping.

In the decision 720, a distinction analysis is carried out for the danger audio volume input 350. For example, such distinction analysis is carried out as follows using the threshold values θd, θt and θ_{T},

### S4 if ((Σ(t=t−θt˜Now)d(θd≦Cdt))<θ_{T})

### S5 otherwise

where d (x) is a function of 1 when equation x is true and 0 when equation x is false. Cdt is a value of Cd at a time t.

If the state with a high danger audio volume does not continue for a fixed time (S4), a safe state (780) is output. If the state with a high danger audio volume continues for a fixed time (S5), the control is shifted to the decision 730.

The threshold values θd, θt and θ_{T} are set up in the parameter setting unit 900. This is a processing performed by the danger audio detection program 300 for a brief voice. This is based on the hypothesis that if an audio danger state continues for a fixed time, it should be decided as dangerous

In the decision 730, a distinctive analysis is performed for the input child audio volume 410. The distinctive analysis is carried out as follows using the threshold values θe, θc and θ_{c},

### S6 if ((Σ(t=t−θc˜Now)d(θe≦Cct))≧θ_{c})

S7 otherwise where d(x) is a function of 1 when equation x is true and 0 when equation x is false. Cct is a value of Cc at a time t.

If the state with a high child audio volume lasts for a fixed time (S6), a safe state (780) is output. If the state with a high child audio volume does not last for a fixed time (S7), the control is shifted to the decision 740. This is a processing performed by the danger audio detection program 300 for brief voice. This is based on the hypothesis that when the child audio volume lasts for a fixed time, that is, in such a state that the child is determined to be talking to a dangerous voice, there is a high probability that the person is acquainted with the child so that the degree of danger is determined to be not as high.

In the decision 740, a decision is made based on the locked state of the device acquired from the external state input unit 600. If the device is locked in order to prevent false reports, a safe state is output (780). If it is not locked, a danger state is output (790).

The locking function of the device has the advantage of reducing the number of false reports, but it also interferes with regular communication. In that case, the locking function is excluded. In this case, the decision 740 immediately outputs a danger state (790).

The following methods are available for outputting the danger state:

### 1. Alarm Output Using a Speaker

### 2. Emergency signal output by radio transmission

### 3. Calling a curator (parent) by radio transmission

### 4. Calling a service center by radio transmission

As one of embodiments of a danger sensing information device 10 of the present invention, software mounting on the cellular phone is possible. If a microphone 110 and an A/D converter 120 in the audio input unit 100, a processor 210, a memory device 220 and an outer state input device 230 in the danger sensing unit and a communication device 910 in the danger information unit 900 are provided from those used in the calling functions and data communication functions of the cellular phone, programs and data in the memory device 220 can be newly introduced so that the advantage is that the product cost can be maintained to be low. In addition, for cellular phone users, the advantage is that there is no need of owning additional cellular terminals.

What is claimed is:

1. A danger sensing information device, comprising:
a voice input unit that fetches outside sound and converts it to audio signals;
a memory unit for storing an audio model for those to be protected;
a calculation unit for calculating the degree of danger by comparing between said audio signals and said audio model for those to be protected; and
an information unit for informing a message to the outside according to the degree of danger.

2. The danger sensing information device according to claim 1, wherein said calculation unit calculates basic frequency of said audio signals to calculate the degree of danger.

3. The danger sensing information device according to claim 1, wherein said memory unit for storing inactive audio models attributed to more than one person, said calculation unit compares between said audio signals and said inactive audio model and determines a lower degree of danger as the degree of matching is higher.

4. The danger sensing information device according to claim 1, wherein said memory unit for storing active audio models attributed to more than one person, said calculation unit compares between said audio signals and said active audio model and determines a higher degree of danger as the degree of matching is higher.

5. The danger sensing information device according to claim 1, wherein said calculation unit measures a noise level of said audio signals to calculate the degree of danger according to said noise level.

6. The danger sensing information device according to claim 1, wherein said memory unit stores a pattern model considering the changes over time in one or more parameters such as said basic frequency, said degree of matching, and said noise level, and said calculation unit calculates the degree of danger according to said pattern model.

7. The danger sensing information device according to claim 6, wherein if the signals for one or more of said basic frequencies and degree of matching of said active audio model continue for a fixed time as said pattern model, but if the signals for one or more of the degree of matching of the audio model of those to be protected and the degree of matching of the inactive audio model do not continue for a fixed time, it requires a higher degree of danger.

8. A cellular phone device, comprising: the functions of the danger sensing information device in claim 1 as one of the functions of the cellular phone; and cellular communication or speaker functions as an information unit.

9. The cellular phone device according to claim 8, wherein an information unit calls a person protecting and performs actions at the time of incoming of the call by generating a calling sound.
